(19) United States
(12) Patent Application Publication
(10) Pub. No.: US 2003/0028888 A1
(43) Pub. Date: Feb. 6, 2003

(54) Systems and methods for providing consumers with entertainment content and associated periodically updated advertising

(76) Inventors: Charles Eric Hunter, Hilton Head, SC (US); Bernard L. Ballou JR., Raleigh, NC (US); Kelly C. Sparks, Morrisville, NC (US); John H. Hebrank, Durham, NC (US)

Correspondence Address: Richard S. Faust, Suite 204, 8384 Six Forks Road, Raleigh, NC, 27615, US

(21) Appl. No.: 10/072,471

(22) Filed: Feb. 7, 2002

Related U.S. Application Data
(63) Continuation-in-part of application No. 09/781,679, filed on Feb. 12, 2001.
(63) Continuation-in-part of application No. 09/781,680, filed on Feb. 12, 2001.
(60) Provisional application No. 60/322,186, filed on Sep. 14, 2001.
(60) Provisional application No. 60/347,440, filed on Nov. 7, 2001.
(60) Provisional application No. 60/322,187, filed on Sep. 14, 2001.
(60) Provisional application No. 60/325,888, filed on Sep. 28, 2001.
(60) Provisional application No. 60/326,583, filed on Oct. 2, 2001.
(60) Provisional application No. 60/328,806, filed on Oct. 15, 2001.

(51) Int. Cl. H04N 7/025; H04N 7/10

(52) U.S. Cl. 725/89; 725/134; 725/34; 725/42

(57) ABSTRACT

A player device for generating audio visual signals representative of entertainment content with advertisements includes a reader mechanism for reading entertainment content pre-recorded on a first medium and reading advertisements pre-recorded on a second medium, and a processor generating command signals inserting advertisements read by the reader mechanism from the second medium into entertainment content read by the reader mechanism from the first medium.

### CROSS REFERENCE TO RELATED APPLICATIONS

This application is a Continuation-In-Part of U.S. patent application Ser. No. 09/781,679, for “Video Distribution System,” filed Feb. 12, 2001 (Reference WT-15), and of U.S. patent application Ser. No. 09/781,680, “Video Distribution System,” Feb. 12, 2001 filed (Reference WT-16), and U.S. patent application Ser. No. ______, filed Jan. 4, 2002 for “Systems and Methods for Distribution of Entertainment and Advertising Content” (Reference WT-27, Attorney Docket No. 08159.0009-00000), all of which are assigned to the assignee of the present application. The disclosures of the aforementioned U.S. patent applications are hereby expressly incorporated herein by reference.

This application claims priority to U.S. Provisional Application, Serial No. 60/326,563, for “System and method for Ultrahigh Reliability, High Density, Short Wavelength Laser Read and Write Data Storage System With Content Protection,” filed Sep. 28, 2001, the contents of which are expressly incorporated herein by reference.

This Application further claims priority to U.S. Provisional Application, Serial No. ______ for “System and Method for Optically Altered DVD (DVDO™),” filed Nov. 7, 2001 (Reference number WT-25), the contents of which are expressly incorporated herein by reference.

This Application further claims priority to U.S. Provisional Application Serial No. 60/322,186, for “Ultrahigh Reliability, High Density Read and Write Data Storage System,” filed Sep. 14, 2001 (Reference number WT19-Prov), the contents of which are expressly incorporated herein by reference.

This Application further claims priority to U.S. Provisional Application Serial No. 60/325,888, for “System and method for Ultrahigh Reliability, High Density, Short Wavelength Laser Read and Write Data Storage System With Content Protection,” filed Sep. 28, 2001, (Reference number WT-22), the contents of which are expressly incorporated herein by reference.

This application further claims priority to U.S. Provisional Application Serial No. 60/326,563, for “System and Method for Ultrahigh Reliability, High Density, Short Wavelength Laser Read and Write Data Storage System With Content Protection,” filed Sep. 28, 2001 (Reference number WT-21), the contents of which are expressly incorporated herein by reference.

### DESCRIPTION

1. Field

This invention relates to systems and methods for providing consumers with entertainment content and advertising content. In certain embodiments, the invention relates to distributing in-home, on-demand entertainment content such as movies and music selections, preferably coupled with periodically updated advertising.

2. Background

The current size and success of the entertainment industry shows the enormous market for audio and video entertainment by consumers. The music recording industry, television and movie industries, and professional athletics, among others, have all seen large economic gains since the dawn of television and radio. In fact, the demand for such broadcast audio and visual content spawned new fora for advertising. However, current methodologies for the distribution and viewing of audio/visual content including music, movies, information, and advertising have become outdated due to substantial steps forward in technology.

Traditionally, consumers, i.e., those watching or listening to the audio/visual content, were forced to view or listen to the content as it was broadcast. Television stations followed specific schedules to let consumers know when their show, movies, information or sporting events would be broadcast. In addition, radio stations broadcast the music or shows according to their set schedules. As a result, the consumer had very little flexibility in deciding when to view their show, or listen to their music. Similarly advertisers were restricted by the schedule to broadcast their advertisements at whatever affordable, available time was most likely to include viewers interested in their products. The system was neither efficient for the advertisers nor convenient for the consumers.

As a result, techniques developed to allow the consumer to record the music or movie from the broadcast for later viewing or listening. Audio cassettes allowed for the capture of audio content. VCR's allowed the consumer to capture audio visual content. In addition, models such as those employed by TiVo and Replay allowed for the capture of such content for later viewing. However, these models required the viewer to know in advance the scheduled broadcast time for their show and to program a device, such as a VCR to record their shows. This required additional cost for the recording device and medium, and time to study the broadcast schedule and to program the recording device accordingly. This scheme, however, adversely impacted advertisers, as consumers watching the recorded content often fast forwarded past any advertisements.

Movie rental stores allow users to rent pre-recorded movies for at-home play, subject to pick-up and return trips to the rental store, availability of movies at the store, and costs and inconvenience associated with lost or damaged media and late returns. Furthermore, movie advertisements (“previews”) contained on the rented movies are locked in time and thereby limited to those upcoming movies at the time the movie is recorded to the medium. Viewers of the pre-recorded movies months or years later are subjected to long outdated previews of little value to them or the advertiser (the movie studio).

More recently, video on demand (or audio on demand) has allowed consumers the ability to modify the schedule of the audio/visual content by simply demanding content at times convenient to the consumer. This technique suffered from two profound limitations. First, the content distributed in this scheme was easily copied and disseminated without the consent of the content providers. In addition, advertisers were further limited in their options, as they now may not even chose the broadcast time for their commercials. Instead, they were limited to transmission of the advertisements at the time demanded by the consumer.

Another limitation of current content distribution schemes is that Digital Rights Management (DRM) schemes are digitally implemented. As technology advances, the processing power available for decryption, collaborative distributed processing efforts such as those utilized to break DES (digital encryption system), have minimized the security of existing DRM models. In addition, the publication of software applications such as DeCSS for cracking DVD, and the availability of unencrypted formats, render the cryptographic analysis of digital keys possible. As a result, estimates place lost revenues due to copied VHS recordings at roughly 30%. Furthermore, in emerging markets such as China, the estimates soar to nearly 80%. Estimates of the loss due to ripped CD's and DVD's are difficult to estimate presently.

It is desirable, therefore to provide a distribution scheme for delivery of audio and video content with increased security and convenience, and higher density (i.e. greater data per disc). In addition, the method should provide the ability to archive audio and video content on secure discs for consumers to view at their convenience. In addition, it is desirable that the method provide the ability to couple fresh, periodically updated advertisements with the audio and video content, even when a customer is enjoying content that he has had archived in his home for months or years. Also, it is desirable that the method provide the ability to better target advertisements to the wants and needs of the consumers who will be watching them.

Current industry practices require complex alliances and strategies for the production and distribution of movies, musical recordings and other content. For example, film actors, independent film makers and music recording artists find themselves generally unable to reach consumers without forging alliances with movie studios or record companies and other players in the chain between the artist and the consumer. These time-honored practices, suitable to an earlier era, have a debilitating effect on the production and distribution of entertainment content. For example, owing in large part to the cost of distribution, the number of major films released in the United States has dropped from approximately 300 films in 1995 to approximately 150 films in 2000. In a self-defeating cycle, films are evermore expensive, making each film a bigger risk. In an effort perceived to lower the risk, those involved feel a need to use more expensive big-name movie stars who may be compensated at ten million dollars per film, and more. It would be desirable to have an alternative system and method for distributing content to consumers, removing i many of the players who currently stand between film actors, independent film makers and music recording artists. This will encourage a vast increase in offerings of movies, music recordings and other content at lower prices, while opening up new opportunities for emerging artists. Such a new paradigm will permit both established artists and other artists essentially to go directly to the customer with the aid of appropriate financial and production services from venture capitalists and the like.

### SUMMARY

A player device for generating audio visual signals representative of entertainment content with advertisements includes a reader mechanism for reading entertainment content pre-recorded on a first medium and reading advertisements pre-recorded on a second medium, and a processor generating command signals inserting advertisements read by the reader mechanism from the second medium into entertainment content read by the reader mechanism from the first medium.

It is to be understood that both the foregoing general description and the following detailed description are exemplary and explanatory only and are not restrictive of the invention, as claimed.

### BRIEF DESCRIPTION OF THE DRAWINGS

The accompanying drawings, which are incorporated in and constitute a part of this specification, illustrate several embodiments and together with the description, serve to explain the principles of the invention.

FIG. 1 is a block diagram showing a distribution model for distributing audiovisual content and advertising content to consumers;

FIG. 2 shows a flowchart depicting the stages for inserting advertisements into viewed content.

FIG. 3 is a block diagram of a set top box including a pair of optical readers, one for the entertainment content and one for updated advertisements (and, optionally, a current content index).

FIG. 4 is a block diagram showing a side view of a disc; and

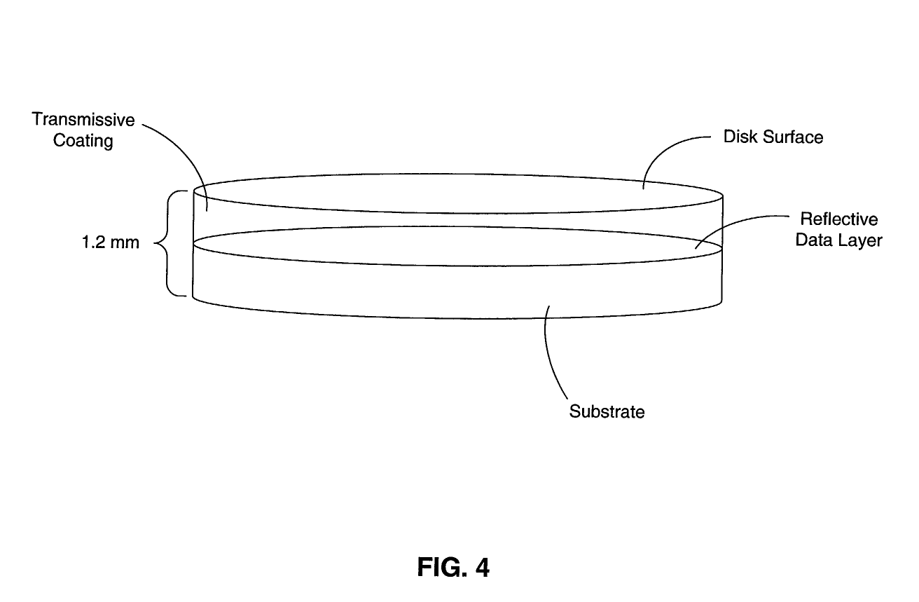

FIG. 5 is a diagram depicting a top-view of a disc.

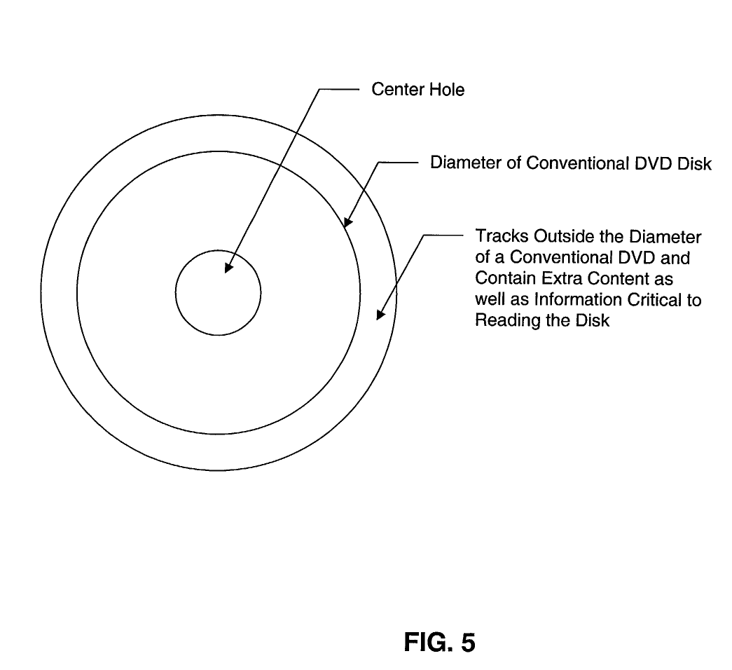

FIG. 6 is a schematic representation of a portable player.

FIG. 7 shows the relationship between a portable player and a set top box.

### DETAILED DESCRIPTION

Reference will now be made in detail to exemplary embodiments, which are illustrated in the accompanying drawings. Wherever possible, the same reference numbers will, throughout the drawings, refer to the same or like parts.

A system and method provide for unrestricted distribution of content-protected discs to consumers, in a manner optimized to meet market conditions. Furthermore, consistent with the present invention, regularly updated advertisements are distributed to customers on an advertisements disc that is shipped periodically, for example, monthly. The advertisements disc preferably includes an index to available and upcoming entertainment content. Each customer also receives a disc player, or “set top box”, that is a relatively inexpensive device including a first reader for reading an entertainment content disc and a second reader for the then-current advertisements disc. Thus, consistent with the present invention, updated advertisements may be shown along with the entertainment content being viewed by the customer. Advertisements may be targeted to customers based on consumer preferences.

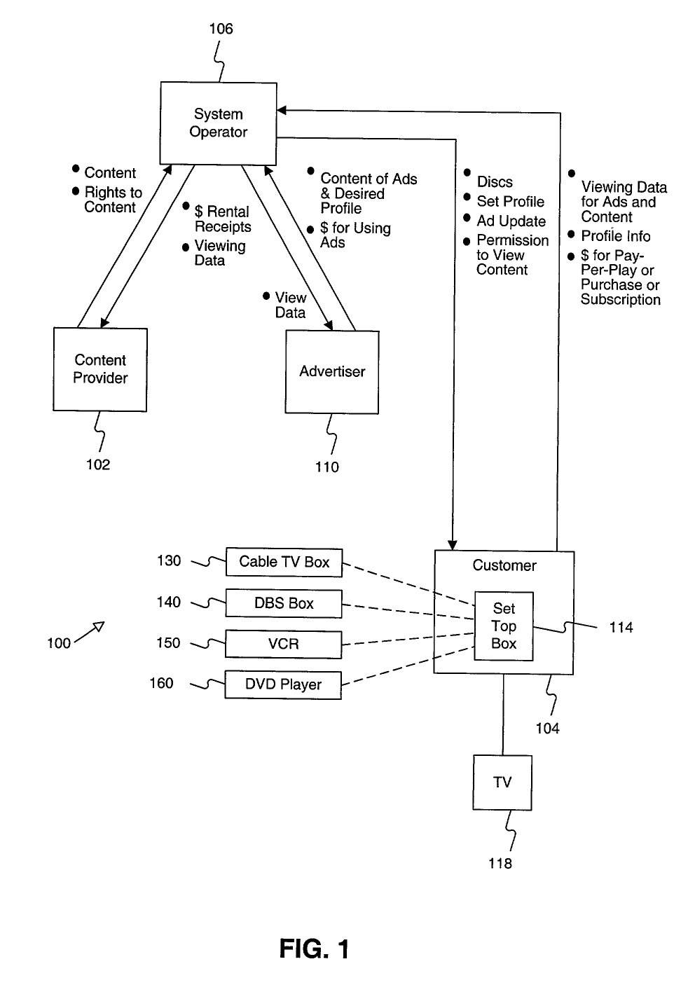

As shown in FIG. 1, the system 100 comprises one or more content providers 102, a plurality of consumer locations 104, a distribution system operator 106, and one or more advertisers 110. Customer locations would watch the distributed content on a device such as a set top box 114. System 100 additionally may contain numerous communications links between the various components of the system, as will be described.

Content provider 102 provides content (i.e. informational content such as shopping catalogs, video content such as movies or TV shows, or audio content such as songs or radio shows).

Consistent with the present invention, the content provider(s) and/or system operator may ship a “startup” package to new customers. Such a startup package may include, for example (i) 20 movie discs containing 120 movies; (ii) three music discs containing 180 CDs/albums; (iii) the then-current advertisements disc (preferably also containing a content index as discussed below); and (iv) a set top box. The startup package may be shipped to new customers free of charge, or at a relatively nominal charge, for example, a charge not exceeding the cost of production and delivery. Upon receipt of the startup package and registration with the system operator to achieve activation, the customer archives the content in his/her personal “library” and thereby has unlimited access to all content in the package. Additionally, entertainment content may be shipped monthly along with each month's new advertising disc. For example, on an ongoing basis, a customer may receive a monthly package including (i) six movie discs (48 movies); (ii) one music disc (60 CD's/albums); (iii) one advertising/index disc.

Additionally, the startup package may include a shopping catalog disc containing catalogs of many of the largest catalog sales companies. The catalog disc may be replaced with an updated catalog disc on a periodic basis, for example, quarterly.

In addition, customers may at any time order available content discs from the system operator for an established charge, typically not exceeding cost of production plus delivery. Optionally, content discs may also be obtained from other distribution agents such as retailers, catalog sales companies, or the like.

The content may be distributed in a protected format such that the distribution system operator may control access to the content and charge for any presentation of the content, either on a pay-per-view basis, a one time fee, subscription or other basis. Preferably, the content is hardware protected, software encrypted, or both, to prevent unauthorized access to the content. The content may be hardware protected by distribution on proprietary discs which are not readable by commercially available hardware. Reading the disc then requires a proprietary set top box 114. In order to receive enabling commands or keys necessary to unlock any encrypted content, a consumer would remit payment to the system operator.

The periodically shipped advertisements disc may be in the same protected format and same medium as the entertainment content discs. Alternately, the advertisements disc may be another medium, for example, conventional DVD or CD.

Consistent with certain embodiments of the present invention, when the customer plays the distributed content via the set top box it is necessary that an advertisements disc reside in the second reader mechanism. At times before, during or after playing of the entertainment content, advertisements from the advertisements disc are played. The advertisements may include current movie “previews”, in which case the advertiser 110 (FIG. 1) may be the same entity as the content provider 102. Commercial advertisements other than movie previews may also be played before, during or after playing the entertainment content. Advertisements may be inserted at insertion points in a manner described in detail elsewhere in the specification.

Following viewing of content by a customer, the system operator sends data regarding the viewings of advertisements, such as the number of viewings, and residential preference information to the advertiser. Such information allows advertiser 110 to modify its advertising approach (i.e. direct advertising campaigns to new preferences). Finally, advertiser 110 submits payment to the system operator.

System operator 106 may submit viewing data, and payment royalties or rental receipts to the content providers.

As stated above, the entertainment content discs are distributed via a secure storage medium. Traditional CDs and DVDs may be used; however, the storage capacity of traditional discs would result in the distribution of great quantities of such discs. In addition, it has become increasingly easy to pirate the content of such discs by ripping the contents from the disc, and decoding it using applications available over the Internet. Instead, optically altered DVDO's™, discussed below, are preferably used to securely distribute the content.

Therefore, once a consumer selects a show for playing, the set top box will play the show with the option of showing advertisements before, during or after the show. The advertisements may be shown upon the set top box occasionally encountering insertion points in the encoded content. As it encounters these insertion points, it will place an advertisement from the advertisements disc in the content for presentation to the consumer.

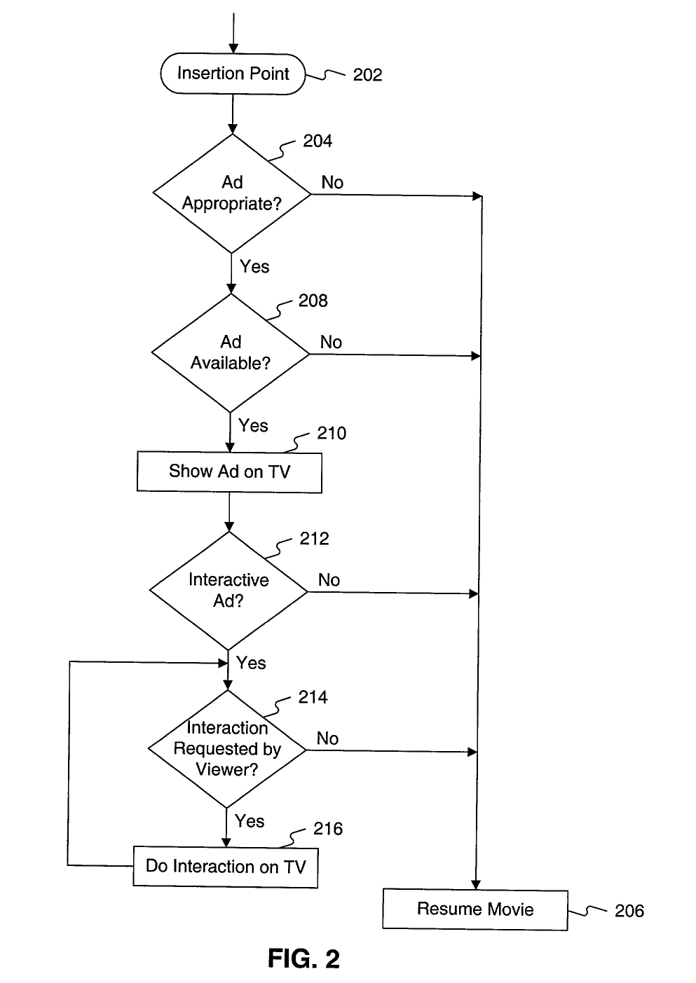

FIG. 2 shows an exemplary method for integrating advertisements at insertion points in the viewed content. As the set top box of the consumer is receiving data via an entertainment content disc for presentation to the viewer, it will occasionally encounter insertion points. An insertion point may be a set of bytes in the content representative of a command to insert an advertisement in the presented content. Consistent with the invention, the command may comprise a pointer to the second reader mechanism containing the advertisements/index disc.

Once the set top box encounters such a command (stage 202), it then determines whether an advertisement is appropriate (stage 204). An advertisement may be appropriate if the insertion point would be a logical place to insert an advertisement for the current residential preference at that customer household. In addition, an advertisement may be inappropriate if it would not make sense to advertise at that point in the content. An advertisement may not be appropriate if the customer has paid the higher rate for the ability to view the content free of advertisements. The residential preference of the customer may reside in the memory of the set top box, or, in one embodiment, may reside on a host computer of the content provider or video distribution system operator. If the set top box determines that an advertisement is not appropriate, it simply resumes playing the content (stage 206).

If, however, the insertion point is appropriate for a commercial, then the set top box must determine if an advertisement is available for insertion (stage 208). In addition, the command to insert an advertisement may specify a location from which to retrieve the advertisement, or may allow the set top box to choose the advertisement based on a predefined algorithm, or based on residential preferences. If an advertisement is not available, the set top box may return to stage 206 to resume playing the content. In addition, the disc containing the content may contain a default advertisement or advertisements (such as to be chosen based on a customer preference), in addition to the insertion command, which may be played if no appropriate advertisement is available.

The set top box then plays the advertisement (stage 210). In addition, the advertisement may be an interactive advertisement (stage 212), in which case the advertisement will allow the user to interact via any known or later developed means (stage 214). In addition, a user may enter commands by inputting commands through a remote control, or communicating via the internet to the advertiser (stage 216).

Once the set top box has completed presentation of the advertisement, and any interaction, the advertisement may contain a return command, commanding the set top box to resume presentation of the content. Such a command allows advertisements to be any length, providing greater flexibility to advertisers.

As stated above, advertisements on the advertisements disc may be conventional sound and images as are currently shown on television, or may be interactive advertisements. In interactive advertisements the viewer can change the displayed material by expressing choices via remote. For example, a truck advertisement may offer the option of extending the advertisement by showing the engine or passenger compartment features, or may even allow a viewer to request printed material. The instructions for accomplishing an interactive ad may be placed in the header material accompanying each advertisement. When an advertisement is selected for playing at an insertion point, the header codes stored at the start of the advertisement will provide the instructions for the box processor to allow interactively by responding to remote inputs at various places in the advertisement. Events such as purchasing products, requests for information, signing up for free trials of a product or entry into contests may all be accomplished over the back channel when the next connection is made. The instruction set for programming interactive advertisements may be similar to HTML code or may be an instruction set that is unique to the system operator. The system and method for providing interactivity and the manner of placing orders for products, product information, or the like, may be carried out in accordance with the teachings of commonly assigned co-pending U.S. patent application Ser. No. 09/645,086, filed Aug. 24, 2000, which is incorporated by reference in its entirety.

This distribution model allows advertisers the flexibility to tailor advertisements more efficiently to specific target audiences. For example, a set top box may be programmed to maintain residential preference information for a household, and to present advertisements that are targeted to the preferences of that residence. In particular, the box may contain a circuit device, which generates a customer preference containing characteristics of a device user. The box can be programmed to select advertisements for presentation on such criteria as the content currently being viewed (romantic comedy, or war movie), historical preferences of content, time of day, location of the box, including zip code or telephone area code, weather, time of year, or demographics of the region. In certain applications, the customer may be permitted to totally avoid the advertisements by paying an increased fee. In the alternative, a consumer could receive content for a reduced or no fee if they are willing to view additional advertisements. This means for generating and using preference information may utilize the systems and methods set forth in commonly assigned co-pending U.S. patent application Ser. No. 09/502,069, filed Feb. 10, 2000, which is incorporated by reference herein in its entirety.

Consistent with the present invention, the distributed content may be encrypted, either by hardware or software (or both). Encrypting the content, such that it may not be accessible to the customer, will allow system operator 106, to control access to the content. For example, hardware encryption, such as can be achieved by optically altering the discs (discussed below), will prevent the discs from being readable by technology currently accessible to consumers. In addition, software encryption will provide further control on access to the content, such that if hardware encryption is somehow broken, viewing the content will still require the user to break the software controls. Such software encryption can use any known or later developed method. Preferably, such a scheme would utilize time sensitive keys that will “expire” after a predetermined amount of time.

An example of a key scheme that may be used is one incorporating three separate, yet dependent keys. For example, a host associated with the content provider can generate a random number (Key A) and transmit it to the consumer's set top box. In addition, the content provider may, through the same or a different schedule, transmit an algorithm, randomly selected from a large number of algorithms (i.e., 3000), to the consumer's set top box. Another key, Key B may reside in the box, for example, in a circuit device. A circuit device within the box will perform the transmitted algorithm on received key A and stored key B. The result will be a third key, Key C. Key C will then be transmitted back to the content provider for comparison to a key stored at the content provider. If the keys match, an enable signal will be sent to the set top box to allow the viewing of the content. In certain applications, it may also be desirable to place a security code on the disc itself. For example, the first words stored on the disc may contain a security code which is oversampled a predetermined number of times.

Consistent with the invention, a user who has received content encoded with software key or keys, may request to view certain content. Upon the request, the box may transmit billing information to the central controller. The central controller may then charge the consumer's account on a rental, purchase, subscription or other basis, and transmit back an enabling command, allowing the set top box to decode and present the requested content.

This distribution scheme also maximizes benefit to the advertisers by providing greater distribution flexibility for advertisers. By selecting the advertisements based on a customer preference, advertisers may analyze the variants to compare sell through for a product in various locations. If any variant in the customer preference proves to be statistically significant in predicting which consumers will purchase the products, consumer preferences and advertisements may be easily modified to better target the audience. This can be done by a feedback loop, which provides data to the system operator or content provider regarding the consumer preferences and the times the advertisement was presented.

In addition, the system operator will be able to charge advertisers directly for advertising. They may charge the advertiser using numerous schemes such as by auctioning advertising time to advertisers based on customer preferences, or by charging the advertisers according to a rate card (i.e., charging a flat rate for each time the ad is presented to a consumer). In addition, demand for advertising within a particular customer preference or demographic can be used to determine advertising rates.

Requiring the system operator to verify the key prior to sending an enabling command also allows the system operator to bill the consumer for the content demanded. In this way, the enabling key may only be transmitted to a consumer who is in good standing with his or her bill. The consumer may be billed on a subscription model (i.e., be billed a flat rate for a period of time), may be billed per viewing of each show, may purchase a show (for unlimited viewings), or other desired billing scheme. In addition, when billing by the number of presentations of an advertisement, the content provider will have the flexibility to bill an advertiser at discounted rates for a large volume of presentations.

The keys and billing information may be sent via any communication means such as a modem, internet connection, POTS telephone line, cellular telephone, cable backchannel, or other means, including, when available, direct broadcast satellite (DBS) backchannel. In addition, in one embodiment, the set top box may contain a credit card or smart card reader for the recording and transmission of payment information.

In addition, the content provider may bill a customer a higher amount for a subscription to view the audio/visual content without advertisements.

Apparatus consistent with the present invention, provides hardware security for the distributed content. The distributed discs may be optically altered DVD's or CD's, (DVDO™). A DVDO is an optically-altered physical medium, which is not readable by currently available consumer players. Such a disc is described in more detail in the above-referenced provisional applications. Consistent with the present invention, an Optically Altered DVD (DVDO™ or DVDOA™) provides content protection in lieu of or in addition to other DRM schemes.

For example, one or more intrinsic optical changes may be made to traditional CD (780 nm) and/or DVD (650/635 nm) read technologies to render the reading of DVDO or optically altered CD (CDO™ or CDOA™ herein referred to as DVDO) impossible by commercially available readers Thus for videos, music, and other content, provided via physically delivered media, a DVDO player is required.

A disc is generally composed of at least two layers, a transmissive outer layer covering a reflective inner data layer. Discs are pressed in this format during the manufacturing process. A typical disc is 1.2 millimeters thick. Currently, the outer transmissive layer on a CD is 1.2 millimeters thick. In addition, for a typical DVD, the transmissive layer is 0.6 millimeters thick, such that the reflective data layer is located in the center of the disc, approximately 0.6 millimeters from either surface. Details of conventional DVD discs are set forth in the DVD-Video Format Book Specification, Version 1.11 published in March 1999 by Toshiba Corporation on behalf of the DVD Forum.

In order to read either CD's or DVD's, an optical reader directs a laser through the transmissive layer, focused on the reflective data layer. Modern technology requires the ability to focus the layer at precisely the depth of the reflective layer, in order to reduce bit error rates.

Consistent with the present invention, a disc is provided in which the inner reflective data layer is closer to the surface of the disc. For example, the transmissive outer layer of the disc may be reduced in thickness from 1.2 mm (for a CD), and from 0.6 mm (for a DVD) to a lesser thickness such that conventional readers are incapable of focusing on the reflective layer. By reducing the thickness of the transmissive layer, the reflective data layer of the disc is brought closer to the optical reader. Especially if used in a reader or player with short wavelength laser diodes, this allows for additional data to be encoded on a single disc (and together with improved error correction schemes), can greatly increase the storage capacity of discs. When used in combination with a larger buffer, the duty cycle, i.e. the time at which the diode is emitting the laser, may therefore be significantly reduced, therefore increasing the usable lifetime of the diode.

In order to read discs of this type, an optical reader will require a laser diode, which can focus on the reflective surface of the disc through a transmissive layer of less than 0.6 mm. To do this, the reader may include a Z-directional focus mechanism such as a drive mechanism capable of moving the disc tray closer to the laser diode or vice versa. In addition, the reader may simply place a laser diode closer to the surface of the disc than a conventional disc reader.

The DVDO may contain a thin coating of material having a high transmissivity at 400-410 nm and low transmissivity at 635-650 nm allowing the proprietary player to drive a 635 lasers at a higher power to penetrate, but preventing commercially available DVD players from reading the disc. Using the higher transmissivity, thinner coatings, a lower power diode may be used to extend the usable life of the diode.

Instead of, or in addition to, reducing the thickness of the transmissive layer, the optical disc may instead be made thicker than conventional discs. This will also change the focal point at which the laser diode must focus to a point outside of the capabilities of conventional DVDs or CDs.

Finally, discs may provide a hardware security feature by incorporating a larger diameter than a conventional CD or DVD. Such a disc must be sufficiently large that they cannot be inserted and played in a conventional CD/DVD player discs may range from about 125 mm to 300 mm.

In addition, a disc may be altered to include two reflective surfaces. The first may consist of a reflective layer for encoding content in a format consistent with and readable by conventional CD or DVD reader standards. The second side of the disc may comprise a reflective layer for encoding content in a format consistent with and readable by the proprietary optical readers consistent with a DVDO. This would allow distribution agents to distribute unencoded content for viewing by all consumers, while simultaneously distributing content which is unviewable without the proprietary reader.

As discussed above, although certain embodiments of the invention use a 635 nM laser to read the disc, and the disc may contain a dye or a preferential pit depth or other method to prevent future optical readers from reading the track and/or symbol spacings that are closer than conventional DVD readers are designed for, future generations of readers may use 405 nM or shorter wavelength laser diodes to read more densely packed tracks and symbols. Furthermore, because the cost of producing content discs is so low, customers using second-generation short-wavelength technology may be provided both new content on higher capacity discs as well as replacement of their older discs that may not be readable on these new readers. Furthermore, other techniques, currently unknown, may allow higher capacity or improved encoding or encryption techniques to be used in this business system.

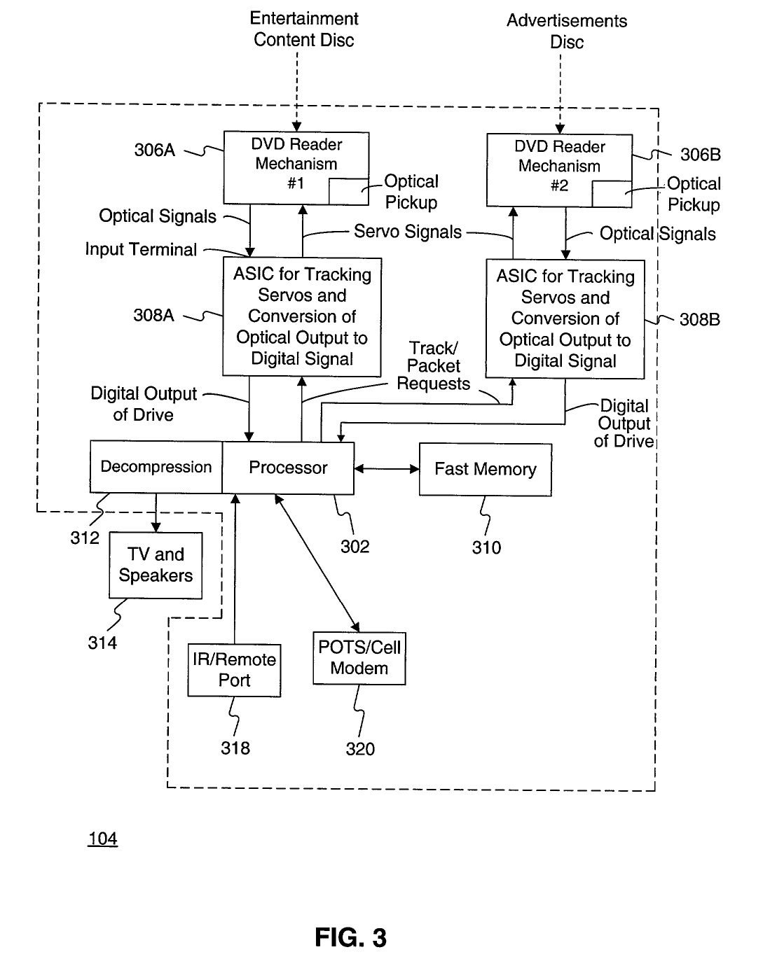

FIG. 3 shows a block diagram of components in one representative set top box 114 consistent with the invention. Set top box 114 includes a processor 302, a first disc reader mechanism 306A, a second disc reader mechanism 306B, integrated circuits 308A and 308B, a fast memory 310, a decompressor 312, and an output 314. In addition, the system may include a remote unit port 318 and a communication interface 320. Consistent with the present invention, integrated circuits 308A, 308B, which may be implemented as ASIC's, may perform one or more of the functions listed above. The processor may perform the functions of any circuit devices described. It will be appreciated that the principal components of set top box 114 may be incorporated into the body of a conventional TV or other display device.

It will be appreciated that the functions of the ASIC's may be achieved by other suitable means well known in the art, for example, by digital signal processing DSP) technology.

First disc reader mechanism 306A reads data from an entertainment content disc, such as a DVD, CD, or optically altered CD or DVD (hereinafter a DVDOA or DVDO). In one embodiment, the disc contains the audiovisual content provided by a content provider. As the data is read by disc reader mechanism 306A, integrated circuit 308A converts the optical output of disc reader 306A to digital signals. This is then output to processor 302 and may be stored in memory, such as fast memory 310. Alternatively, the output may be sent to decompressor 312 for decompression into output signals to be sent to TV and speakers 314. In a similar fashion, second disc reader mechanism 306B reads data from the then-current advertisements/index disc, and integrated circuit 308B converts the optical signals to digital signals. It will be appreciated that the content disc and advertisements disc may be read by a single optical pickup in a carousel or disc changer apparatus or other similar apparatus wherein the content disc (first medium) and the advertisements disc (second medium) are mechanically, sequentially moved for reading. In this instance, content may need to be buffered for a short period of time to achieve a seamless transition between entertainment content and advertisements.

Modem 320 may be used as a back channel connection to the content provider such as for communicating a play request to the content provider, or for receiving billing information. In addition, modem 320 may be used to communicate billing information, to receive A codes, algorithms or enabling commands for security purposes. Finally, modem 320 may be used to communicate customer preference information between the set top box 300 and a content provider.

Many consumers may not have a phone jack near their TV or may prefer to frequently move their player box to different locations in their home so that a wireless back channel link is preferred. A two-way wireless link may be accomplished using the same or similar technology used for conventional 49 megahertz, 900 megahertz or 2.4 gigahertz “cordless” phones. For example, a 900 MHz link would have a transmitter/receiver/antenna on the box as well as a transmitter/receiver/antenna connected to a phone jack. This system may encode and decode the signals according to conventional analog modem technology so that the wireless link would communicate via an essentially analog signal. As wireless technology advances, the wireless link may be digital with a direct digital connection to a DSL phone or internet port.

Although the embodiment of set top box 114 shown in FIG. 1 has a wired or wireless connection to a normal (POTS) telephone line, in some situations of limited phone access a cellular back-channel link may be desirable. The two-way cellular communication may be accomplished through analog means using conventional modem technology, or via a direct digital communication as is the technology in newer cellular phones. A cellular back channel link will be particularly useful for portable players where the opportunity or desirability of connecting to a POTS line is low, or in countries or regions where cellular phones are more common than POTS telephones.

Set top box 114 includes an input circuit for receiving a permission signal. The circuit generates an enable signal, enabling a circuit device to process the data read by the optical pickup assembly into display signals. The functions of the input circuit may be incorporated into processor 302. Some or all of the functions of the circuit device may be incorporated in processor 302 or integrated circuit 308A/308B.

Box 114 may also contain a terminal 117 for Emergency Feedback and Notification System (EFAN) compatibility. EFAN is described in commonly assigned U.S. patent application Ser. No. 09/990,450, entitled “System and Method for Emergency Notification Content Delivery,” filed Nov. 21, 2001, the contents of which are incorporated herein by reference.

Set top box 114 may contain an interface for downloading content to a remote (e.g., portable) unit, together with any necessary keys. The remote unit may be carried with a consumer away from the home and set top box.

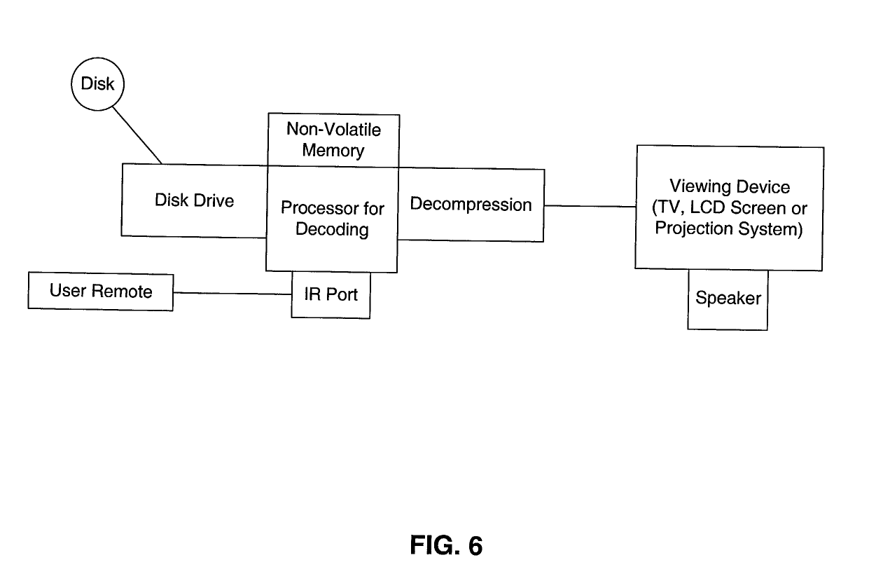

Portable players may take many forms. The simplest player may only play previously purchased music, such purchase information being conveyed to the portable player by the customer or via a link to his home box or the central computer system (for example via an internet connection). A similar portable player (FIG. 6) may play both music and connect to a TV for playing video content.

Portable players may or may not contain the ability to read both content and advertising discs. One embodiment of a portable player may have one drive and require insertion of the ad disc prior to playing a movie so that various advertising or index content is cached in player memory. Portable players may even have sufficiently large memory, perhaps by a small hard drive, so that extensive content may be cached, even including an entire movie. Other forms of advertising on single-disc portable players may involve showing some or all of advertising that is placed on the content disc. These advertisements may be different (e.g., branding advertisements) from the types of advertisements typically carried on the advertisements discs since they would not change monthly but would exist for the life of the content disc. Customers may also have the option of renting ad-free content by paying a higher price to play or purchase a movie.

Content may be displayed on different forms of portable boxes by different technologies. Some may connect to a conventional TV set allowing a customer to carry a portable player with them to on a vacation where conventional TV is available. Another form of the portable box may have a small LCD color screen so that a customer's children might watch a movie while sitting in the back seat of a car. Another embodiment of a portable box may use a projection technology to allow display of a larger image on a wall or screen. For example, a group of children might watch Bambi at a slumber party by projecting the movie on a bedroom wall. One embodiment of a projection-style portable player may use a solid state light source such as multiple (e.g., eight to ten) white LED's that excite light emitting phosphors to produce video images without the heat of incandescent bulbs and the associated fire or burn hazard. Another embodiment may use digital light processing technology developed by Texas Instruments, USA.

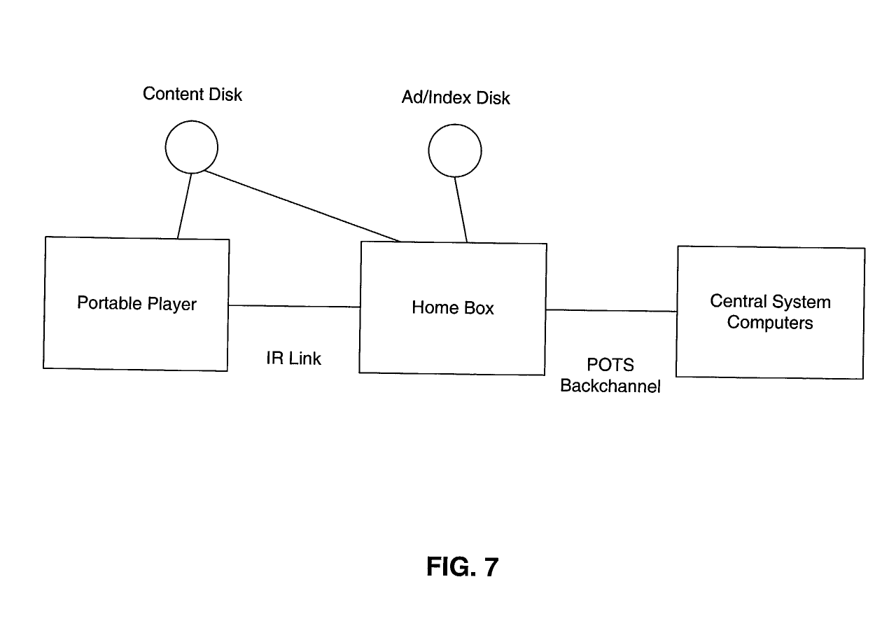

Backchannel communication for extending viewing credit and communicating the content viewed or purchased for proper allocation of movie royalties is desirable for portable players. One method of communication is through having the portable player communicate with a home player and the home player communicate information through its back channel to the central computers. As shown in FIG. 7, communication between a portable and home player may be conducted via an IR link between the two players using encrypted information and conventional IR communication standards. The IR ports used for this communication could also be the receivers for use with the customer's remote. Credit or information sent to a portable box may be stored in non-volatile memory such as flash RAM. The same sort of memory may record the identity of the content played for later communication to the home box.

In normal operation, the home box may be instructed by the central system to extend permission for some quantity or time period for viewing on the portable player. Such permission may be based upon prior payment history, viewing patterns or amount of credit extended to the system by a debit or credit card. In addition to viewing permission the home box may communicate decoding keys, possibly based on the portable player's ID or clock, or parent-set requirements for pin numbers required for viewing some or all material.

Another method of extending viewing permission to a portable player is by a physical connection to a home player (set top box 114) such as via a direct wire link, a replaceable chip or swiping a smart card. In various embodiments these connections may be established before, during or after the playing of content according to the methods established by the system operator. Another may send customers a monthly card that communicates viewing permission to a portable player as a part of a viewing “club” similar to other club models in which members are sent music recordings monthly upon payment of a club fee. In the club model, use of the back channel to extend credit and communicate viewing information may be unnecessary.

For both the home and portable readers, a single drive that contains both the content and the advertisements discs may allow a smaller and lower-cost system to be built. With a two-disc drive, the two discs may be placed on a single spindle with optical pickups above and below. The inner and/or outer diameters of the two discs may be different to facilitate loading or positioning the two discs on a single spindle. The advertising/index disc may be below with its side to be read facing downward, and the side of the content disc to be played faces upward and is readable by the optics above the discs. The two discs may be both placed on a tray that slides into the reader or placed from the top, one disc at a time. One preferred embodiment, as discussed above, is for the bottom disc (the advertising disc) to be changed only on a monthly basis while the upper disc (content) is changed as new movies (or music) are selected from other discs. Because it is desirable to have distinct visual labels on discs, both the advertising and content discs may be single-side so that the non-read side can carry an easily read label.

Having the two discs back-to-back with a single insertion tray and a single servo for disc rotation can allow portable readers to be smaller and lower cost. Since there is never a need for simultaneous reading the advertising and content discs, a single servo can spin both discs at the same speed. Depending upon desired bit rate and radial position on the disc, the servo may change speed when flipping from one disc to the other. Similarly, it may be desirable to consolidate the two radial servos into a single unit that carries both heads. Again when switching from reading one disc to the other, the radial servo may need to move a significant amount. It may also be desirable to consolidate the electronics to drive the rotational and radial servos as well as the pickup and fine tracking electronics into a single board, again reducing size and cost. Content may be buffered for the few seconds required to change the radial position, change the angular velocity and locate the advertising or content material that the system will play. This short buffering may be accomplished by the dynamic memory associated with the box's processor. In some embodiments the two pickups for the two discs may be of different wavelengths to meet cost, protection or legacy constraints.

Also, set top box 114 may contain an interface for downloading music to a recording device so that a customer may record purchased music onto a standard medium (e.g., CD) for enjoyment in other players in the home or automobile. The downloading of purchased music for this purpose may be limited to a certain number, for example, one or two downloads.

Improved protection to piracy of video content is available for movies played on set top box 114. Copying of movies played from either conventional VHS or DVD players can be accomplished by recording the video and sound as it is electrically passed from a player to a TV set. This form of piracy may be limited by encoding a number unique to the box or account being used by the box in the video or audio signal by techniques known as “watermarking”. The watermarks containing the identity number may be visible or audible to the consumer or may be hidden so that decoding of the electronic signal is required to determine encoded identity number. With watermarking, direct copying of the video signal is reduced because the identity of the copier can be determined by examination of the illegal copy. Customer's contracts can include a penalty for unauthorized recording and playback of copies. This provides a realistic disincentive to pirates beyond conventional DVD or VHS players. Watermarking techniques that may be used are discussed in commonly assigned copending application Ser. No. 09/487,978, filed Jan. 20, 2000.

Implementation of the present invention may be carried out in large measure using existing infrastructure. More particularly, existing electronics manufacturers may be utilized to manufacture set top boxes 114, as well as the portable players. Set top boxes 114 are proprietary due to their unique features such as DVDOA™ security features, resulting in increased incentive for electronic manufacturers to be involved. Additionally, existing international parcel delivery companies, or one such company such as Federal Express, have the capability to deliver the set top boxes and discs to customers throughout the world. The same companies have established “backroom” infrastructure, communications capabilities and billing expertise to handle many of the communications and/or billing needs of the system. Furthermore, content providers have many incentives, discussed herein, to participate. In addition to making available current and deep catalog movies and music recordings, the content providers will be afforded extraordinary flexibility with respect to new and syndication properties, such as TV series. For example, the new episodes of a TV series (e.g., 12 episodes) may be shipped to consumers on a disc with a time-based pricing schedule. The episodes may be made available all at once for, say, $1.50 per episode, while as a consumer alternative, the shows may be made available at $0.75 per episode if the shows are unlocked for viewing on a one show per week basis over twelve weeks—in accordance with the current TV broadcast model.

As shown in dashed lines in FIG. 1, the output from a customer's cable TV set top box 130 or direct broadcast satellite (DBS) set top box 140 may be routed through set top box 114 to TV 118. In this embodiment, set top box 114, through the advertising disc then residing therein, may be used to insert advertisements into cable TV or DBS programming by either overriding broadcast advertisements or filling in broadcast spaces left open for advertisement insertion. To this end, cable TV 130 or DBS box 140 streams a signal (typically, an analog signal) with an analog header that directs box 114 to insert an advertisement according to the insertion technique described above in connection with FIG. 2, or other suitable technique. The inserted advertisement may be selected from the available advertisements on the advertisements disc according to customer preferences. Preferably, information concerning the advertisements that are played is stored in memory at box 114 and communicated to the central computer of the system operator when the box is queried. Additionally, as shown in FIG. 1, the output from a customer's VCR 150 or DVD player 160, or other similar device, may be routed through box 114 for convenience in wiring between the various boxes and the TV.

It will be appreciated that the terms “consumer”, “customer”, “viewer” and “user” are at times used interchangeably herein to refer to those who view and listen to the content. Also, the term “advertisements disc” has been used for convenience to refer to those discs (the second medium) that contain advertisements, with it being understood that the advertisements discs may also contain an index to available and upcoming entertainment content, as well as other information. Finally, the term “entertainment content” has been used for convenience herein to refer to the content on the first medium—the content that is viewed and listened to primarily for entertainment, with the understanding that the content on the first medium may contain other information.

Other embodiments of the invention will be apparent to those skilled in the art from consideration of the specification and practice of the invention disclosed herein. It is intended that the specification and examples be considered as exemplary only, with a true scope and spirit of the invention being indicated by the following claims.

What is claimed is:

1. A method of providing a consumer with entertainment content coupled with updated advertisements, comprising:
recording entertainment content on a first medium;
recording advertisements on a second medium;
distributing entertainment content pre-recorded on the first medium to customer locations;
periodically distributing advertisements pre-recorded on the second medium to customer locations;
inserting a first medium containing customer-selected, pre-recorded entertainment content into a player device;
inserting a second medium containing pre-recorded advertising content into the player device;
displaying the selected entertainment content at the customer location via the player device; and
displaying advertisements from the second medium at times before, during, or after display of the selected entertainment content.

2. The method of claim 1 wherein the first medium has a hardware security feature such that display of the entertainment content is possible only upon a player device including hardware compatible with the hardware security feature.

3. The method of claim 1 wherein the first medium and the second medium both have a hardware security feature such that display of the entertainment content is possible only upon a player device including hardware compatible with the hardware security feature.

4. The method of claim 3 wherein the first medium and the second medium are the same medium.

5. The method of claim 1 wherein the step of recording on the second medium includes recording both advertisements and an index of entertainment content.

6. The method of claim 1 wherein the advertisements include current movie previews.

7. The method of claim 6 including the step of displaying the movie previews before displaying the selected entertainment content.

8. The method of claim 1 wherein the advertisements include commercial advertisements other than movie previews.

9. The method of claim 8 wherein the commercial advertisements other than previews are displayed before displaying the selected entertainment content.

10. The method of claim 8 wherein the entertainment content includes insertion points for display of advertisements, and including the step of displaying advertisements from the second medium at the insertion points.

11. The method of claim 1 including the step of generating customer preferences by analysis of customer characteristics and selecting a subset of the advertisements contained in the second medium based upon customer preference.

12. The method of claim 1 wherein the first medium comprises a disc having a diameter greater than about 125 mm and less than 300 mm.

13. The method of claim 1 wherein the first medium comprises a disc having data recorded on a reflective layer and an optically transmissive coating having a total transmission of 635 nm of less than the minimum transmission set forth as the standard DVD specification.

14. The method of claim 1 including the step of downloading content from the player device to a second portable player device.

15. A player device for generating audio visual signals representative of entertainment content with advertisements, said device comprising:
reader mechanism reading entertainment content prerecorded on a first medium and reading advertisements pre-recorded on a second medium; and
a processor generating command signals inserting advertisements read by the reader mechanism from the second medium into entertainment content read by the reader mechanism from the first medium.

16. The player device of claim 15 wherein the reader mechanism comprises a first reader for reading the first medium containing the entertainment content and a second reader for reading the second medium containing the advertisements.

17. The player device of claim 16 wherein the first and second media reside one over the other in the player device for reading, and the device includes one reader above the top disc and the other reader below the bottom disc.

18. The player device of claim 15 wherein the reader mechanism includes a single optical pickup.

19. The player device of claim 18 wherein the first and second media are mechanically, sequentially moved for reading.

20. The player device of claim 16 including a memory device storing read data to permit seamless, uninterrupted insertion of advertisements into entertainment content.

21. The player device of claim 15 including an input for displaying signals from a broadcast content source (e.g., cable TV or direct broadcast satellite) and inserting advertisements prerecorded on the second medium into the broadcast content.

22. A method of providing consumers with entertainment content coupled with updated advertisements, comprising:
distributing to each consumer (i) a plurality of first media, each first medium containing pre-recorded movies, music selections, information or other content, (ii) at least one second medium containing a plurality of prerecorded advertisements, and (iii) a player device having the capability to read both the first and second media;
periodically, for example monthly, distributing pre-recorded advertising on a second medium;
playing consumer-selected entertainment content via the first medium; and
at times before, during or after the playing of the entertainment content, playing advertisements via the second medium.

23. The method of claim 22 wherein the second medium contains an index of available entertainment content.

24. The method of claim 22 wherein the step of distributing items (i), (ii) and (iii) to customers is free of charge to the customer.

25. The method of claim 22 wherein the step of distributing items (i), (ii) and (iii) to customers is at a charge to customers not exceeding production and shipping costs.

26. The method of claim 22 wherein the customers are provided with the entertainment content and updated advertisements without the necessity of the customers having cable TV or direct broadcast satellite service.

27. The method of claim 22 including the step of inputting display signals from a broadcast source (e.g., cable TV or direct broadcast satellite) into the player device and inserting advertisements pre-recorded on the second medium into the broadcast content.

28. The method of claim 22 including the step of shipping entertainment content on first media to customers on a periodic basis.

29. The method of claim 28 wherein the periodic shipments are targeted to customer preferences.

30. The method of claim 22 wherein the entertainment content includes insertion points for display of advertisements, and including the step of displaying advertisements from the second medium at the insertion points.

31. The method of claim 22 including the step of consumers archiving first media.

32. The method of claim 22 including the step of charging customers for playing entertainment content on a play-per-view basis.

33. The method of claim 22 including the step of charging customers for playing entertainment content on a subscription basis.

34. The method of claim 22 including the step of charging customers for playing entertainment content on a one time fee-to-own basis.

35. The method of claim 22 including the step of communicating information that is representative of the playing of entertainment content and advertisements between the customer and a system operator.

36. The method of claim 22 including the step of downloading content from the player device to a second portable player device.

37. The method of claim 36 wherein the portable player device includes a projector.

38. The method of claim 22 wherein the step of playing entertainment content from the first medium is carried out by an optical reader operating at or below 405 nm.
